(19) United States
(12) Patent Application Publication
(10) Pub. No.: US 2022/0113062 A1
(43) Pub. Date: Apr. 14, 2022

(54) MULTIFUNCTIONAL HANDLE-TYPE ELECTRICAL BLOW DRYER

(71) Applicant: Yuyao Hengzheng Metalware Co., Ltd., Zhejiang Province (CN)

(72) Inventor: Chaoqiang Zhou, Shaoyang (CN)

(73) Assignee: Yuyao Hengzheng Metalware Co., Ltd., Zhejiang Province (CN)

(21) Appl. No.: 16/648,775

(22) PCT Filed: Apr. 12, 2019
(86) PCT No.: PCT/CN2019/082522

§ 371 Date: Mar. 19, 2020

(30) Foreign Application Priority Data
May 31, 2018 (CN) 201810553018.2

(51) Int. Cl. F24H 15/128; G08B 21/18; G08B 3/10; H04N 7/18; G06V 20/50; G06T 5/00; G06T 7/194; F24H 3/00

(52) U.S. Cl. CPC F24H 15/128; G08B 21/182; G08B 3/10; H04N 7/188; H04N 5/23299; G06T 5/009; G06T 7/194; F24H 3/002; G06V 20/50

(57) ABSTRACT

A multifunctional handle-type electrical blow dryer includes a temperature measuring device installed on a housing of the electrical blow dryer for measuring a temperature at the housing of the electrical blow dryer to obtain and output a corresponding on-site measured temperature; an on-site alarm device for performing a corresponding voice alarm operation when the on-site measured temperature is over-limit; a data testing mechanism includes an ultrasonic transmitting device, an ultrasonic receiving device and an air-temperature testing device. The ultrasonic transmitting device is installed on the high definition camera for transmitting an ultrasonic signal towards the ground and recording the time of transmitting the ultrasonic signal. The ultrasonic receiving device is installed on the high definition camera, near the ultrasonic transmitting device, for receiving the ultrasonic signal transmitting from the ultrasonic transmitting device to the ground and reflected from the ground. This invention improves the function of an electrical blow dryer.

### CROSS REFERENCE TO RELATED APPLICATION

Priority is claimed to International PCT application PCT/CN2019/082522 filed Apr. 12, 2019 which claims priority to China patent application number 201810553018.2 filed May 31, 2018, both of which are incorporated herein by reference in their entirety.

### FIELD

The present disclosure relates to the field of handle-type electrical blow dryers, in particular to a multifunctional handle-type electrical blow dryer.

### BACKGROUND

### Description of the Related Art

Blow dryer is generally formed by assembling a set of electrical heating wires and a small high-speed fan. When power is applied, the heating wires generate heat, and the wind blown by the fan passes through the heating wires and turns the air into hot air. If only the small fan is rotated and the heating wires are not heated, then the wind blown out from the blow dryer will be ordinary wind only, but not hot wind.

Due to the issue of high heat dissipation of the electrical blow dryer, surrounding objects may be damaged or adversely affected by the electrical blow dryer easily, especially when there is no one around or lack of monitoring.

### SUMMARY

To overcome the drawback of the conventional blow dryer that is incapable of preventing blowing or melting nearby soaps, the present disclosure provides a multifunctional handle-type electrical blow dryer to obtain a distribution area with the existence of a target and a non-distribution area without the existence of the target and the blow dryer implements a differential image division mode and uses a high precision foreground cutting mechanism to facilitate various subsequent image operations; and the timing of contrast enhancement of the high-definition image and its number of times are determined based on a preliminary detection result of the target quantity of the image, so as to avoid unnecessary waste of computing resources. This blow dryer further uses the permanent-magnet brushless motor to correct the current position of the high definition camera and ensures the accuracy of the subsequent measurement result based on the ultrasonic wave propagation speed correction mechanism for testing. On the basis of the aforementioned high precision image processing, a custom detection of a soap target near the electrical blow dryer is performed to prevent the electrical blow dryer from blowing and melting the soap.

According to an aspect of the present disclosure, a multifunctional handle-type electrical blow dryer is provided that comprises: a temperature measuring device, installed on a housing of the electrical blow dryer, and provided for measuring the on-site temperature of a position where the housing of the electrical blow dryer is situated to obtain a corresponding on-site measured temperature and output the on-site measured temperature; an on-site alarm device, installed on a side of the temperature measuring device, for receiving the on-site measured temperature, and performing a corresponding voice alarm operation when the on-site measured temperature is over-limit; a data testing mechanism, comprising an ultrasonic transmitting device, an ultrasonic receiving device and an air-temperature testing device, and the ultrasonic transmitting device being installed on a high definition camera and provided for transmitting an ultrasonic signal towards the ground and recording the time of transmitting the ultrasonic signal, and the ultrasonic receiving device being installed on the high definition camera and disposed near the ultrasonic transmitting device for receiving the ultrasonic signal transmitted by the ultrasonic transmitting device in a direction towards the ground and reflected from the ground, and recording the time for receiving the ultrasonic signal ground transmitted by the ultrasonic transmitting device and reflected from the ground, and the air-temperature testing device being installed on the high definition camera for testing the air temperature of the environment of the high definition camera and outputting the tested air temperature as a current air temperature; a DSP chip, coupled to the air-temperature testing device, the ultrasonic transmitting device and the ultrasonic receiving device, for calculating a vertical height of the high definition camera from the ground as a current height output based on the current air temperature, the time of transmitting the ultrasonic signal and the time for receiving the ultrasonic signal, and the DSP chip further comprising a built-in storage unit for storing a temperature-speed comparison table, and the temperature-speed comparison table having an ultrasonic wave propagation speed corresponding to each temperature range, and the temperature-speed comparison table using the temperature range as an index value, and the storage unit being provided for storing a predetermined height which is a shooting height set by the high definition camera; the calculation for the DSP chip to obtain the vertical height of the high definition camera from the ground based on the current air temperature, the time of transmitting the ultrasonic signal and the time of receiving the ultrasonic signal comprising the steps of: obtaining the temperature-speed comparison table from the storage unit, confirming a temperature range of the current air temperature to obtain a corresponding ultrasonic wave propagation speed from the temperature-speed comparison table and use the ultrasonic wave propagation speed as a current propagation speed, and calculating the vertical height of the high definition camera from the ground based on the current propagation speed, the time of transmitting the ultrasonic signal and the time of receiving the ultrasonic signal; a high definition camera, installed on the housing of the electrical blow dryer, for performing a high-definition camera operation to an environment of the electrical blow to output a high-definition camera image; a permanent-magnet brushless motor, coupled to the DSP chip and the high definition camera, for receiving the current height and the predetermined height, and controlling the high definition camera to adjust the position of the high definition camera from the current height to the predetermined height; a type analysis device, coupled to the high definition camera, for receiving the high-definition camera image, and analyzing the amplitude of various noise in the high-definition camera image to confirm a primary noise type of the largest amplitude and a of the second largest amplitude secondary noise type; a type selection device, coupled to the type analysis device, for receiving the primary noise type and the secondary noise type, and confirming a corresponding primary filtering mode based on the primary noise type, and confirming a corresponding secondary filtering mode based on the secondary noise type; a filter execution device, coupled to the type analysis device and the type selection device, for using the primary filtering mode to execute a filtering process of the high-definition camera image, and then using the secondary filtering mode to execute a filtering processing of the filter processing result to obtain a two-stage filtered image; a sub-image fetching device, coupled to the filter execution device, for receiving the two-stage filtered image, and performing a contour fetch of each target in the two-stage filtered image to obtain each distribution area of each target in the two-stage filtered image, and also used for splitting blocks of the two-stage filtered image to obtain each sub-image; a foreground cutting device, coupled to the sub-image fetching device, for receiving each sub-image of the two-stage filtered image, and detecting a dynamic range of each sub-image, and adjusting a threshold of the sub-image used in a stripping background for each sub-image based on the width of the dynamic range, and further executing the following for each sub-image: using the adjusted threshold for performing a foreground fetch of the sub-image to obtain a corresponding foreground area, and combining each corresponding foreground area of each sub-image, and performing a fitting processing of the combined result to obtain a foreground operation image, and outputting the foreground operation image; the adjustment of the threshold of the corresponding sub-image used for the stripping background based on the width of the dynamic range in the foreground cutting device including a condition: the larger the dynamic range, the larger the threshold of the corresponding sub-image used for the stripping background; a smoothing device, coupled to the foreground cutting device, for receiving the foreground operation image, and executing a smoothing of the foreground operation image for a number of times corresponding to a signal-to-noise ratio of the foreground operation image to obtain and output a corresponding multiple-times smoothed image; a target preliminary testing device, coupled to the smoothing device, for receiving the multiple-times smoothed image, and detecting an existence of each target in the multiple-times smoothed image, and using the quantity of targets existed in the multiple-times smoothed image as a current target quantity, and outputting the current target quantity; an image decision device, coupled to the target preliminary testing device, for receiving the current target quantity, and issuing an excessive target signal when the current target quantity is over-limit, and issuing a target normal signal when the target quantity is not over-limit; a contrast enhancement device, coupled to the target preliminary testing device and the target decision device, for receiving the multiple-times smoothed image, and executing a contrast enhancement of the multiple-times smoothed image to obtain a corresponding contrast enhanced image when the excessive target signal is received, and executing a contrast enhancement of the multiple-times smoothed image for a number of times directly proportional to the current target quantity; a content analysis device, coupled to the contrast enhancement device, for receiving the contrast enhanced image, and performing a content match of the contrast enhanced image and a soap standard profile to confirm a content match percentage, and confirming an existence of the corresponding soap if the content match percentage is greater than or equal to a predetermined percentage threshold, or else confirming a non-existence of the corresponding soap; wherein the on-site alarm device is coupled to the content analysis device for performing a corresponding voice alarm operation when the content analysis device confirms the existence of the corresponding soap.

In the multifunctional handle-type electrical blow dryer, the contrast enhancement of the multiple-times smoothed image is stopped in the contrast enhancement device when the target normal signal is received.

In the multifunctional handle-type electrical blow dryer, the on-site alarm device is provided for stopping the corresponding voice alarm operation when the on-site measured temperature is not over-limited.

In the multifunctional handle-type electrical blow dryer, the on-site alarm device is provided for stopping the corresponding voice alarm operation when the non-existence of the corresponding soap is received.

In the multifunctional handle-type electrical blow dryer, a uniform division is performed in each distribution area in the sub-image fetching device and includes the condition: the larger the distribution area, the larger the size of the divided and obtained sub-image.

In the multifunctional handle-type electrical blow dryer, a uniform division of the two-stage filtered image is performed in each distribution area to obtain a sub-image with a size smaller than the size of the sub-image obtained without performing the uniform division in the distribution area.

In the multifunctional handle-type electrical blow dryer, the permanent-magnet brushless motor is provided for adjusting the position of the high definition camera from the current height to the predetermined height and then transmitting a position home bit signal.

In the multifunctional handle-type electrical blow dryer, the high definition camera is provided for starting a shooting operation of the high-definition camera image when the position home bit signal transmitted by the permanent-magnet brushless motor is received.

### BRIEF DESCRIPTION OF THE DRAWING

FIG. 1 is a schematic view of a multifunctional handle-type electrical blow dryer in accordance with an embodiment the present invention.

### DETAILED DESCRIPTION

To make it easier for the examiner to understand the objective of the present disclosure, its structure, innovative features, and performance, various embodiments together with the attached drawings for the detailed description of the present disclosure are provided.

In the FIGURE, reference numerals and their respective parts are as follow: high definition camera 1, data testing mechanism 2, on-site alarm device 3, temperature measuring device 4, DSP chip 5, permanent-magnet brushless motor 6, type analysis device 7, type selection device 8, filter execution device 9, sub-image fetching device 10, foreground cutting device 11, smoothing device 12, target preliminary testing device 13, image decision device 14, contrast enhancement device 15 and content analysis device 16.

Blow dryer is mainly used for drying and shaping hair, and it can also be used for local drying, heating, physiotherapy and areas such as laboratories, physiotherapy laboratory and industrial. According to the type of electric motor used, the blow dryer is divided into AC series, AC shaded pole, and DC permanent magnet. The series blow dryer has the advantages of high starting torque and high speed, and thus it is suitable for the manufacture of high power blow dryers, and the series blow dryer has the disadvantages of high noise, and interference to telecommunication equipment caused by the commutator.

The shaded pole blow dryer has the advantages of low noise, long life and no interference to telecommunication equipment and the disadvantages of low rotating speed, poor starting performance and heavy weight. The permanent magnet blow dryer has the advantages of light weight, high rotating speed, simple manufacturing process, low manufacturing cost, and high value.

To overcome the aforementioned deficiencies of the prior art, the present disclosure provides a multifunctional handle-type electrical blow dryer to solve the corresponding technical problems effectively.

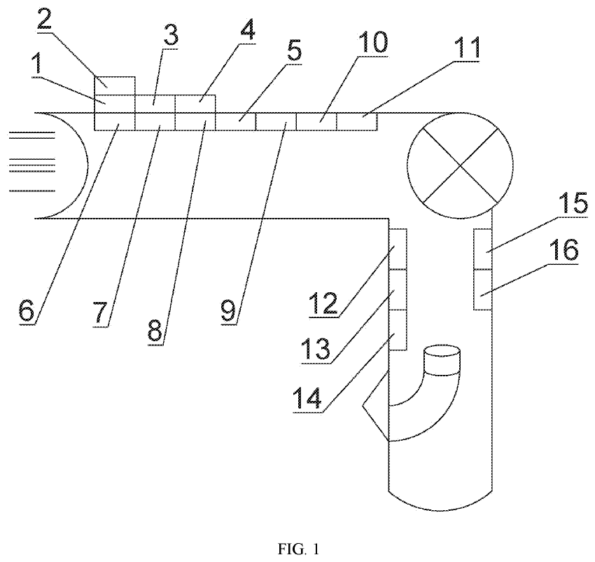

With reference to FIG. 1 for a schematic view of a multifunctional handle-type electrical blow dryer in accordance with an embodiment of the present disclosure, the electrical blow dryer comprises:

a temperature measuring device, installed on a housing of the electrical blow dryer, and provided for measuring the on-site temperature of a position where the housing of the electrical blow dryer is situated to obtain a corresponding on-site measured temperature and output the on-site measured temperature;

an on-site alarm device, installed on a side of the temperature measuring device, for receiving the on-site measured temperature, and performing a corresponding voice alarm operation when the on-site measured temperature is over-limit;

a data testing mechanism, comprising an ultrasonic transmitting device, an ultrasonic receiving device and an air-temperature testing device, and the ultrasonic transmitting device being installed on a high definition camera and provided for transmitting an ultrasonic signal towards the ground and recording the time of transmitting the ultrasonic signal, and the ultrasonic receiving device being installed on the high definition camera and disposed near the ultrasonic transmitting device for receiving the ultrasonic signal transmitted by the ultrasonic transmitting device in a direction towards the ground and reflected from the ground, and recording the time for receiving the ultrasonic signal ground transmitted by the ultrasonic transmitting device and reflected from the ground, and the air-temperature testing device being installed on the high definition camera for testing the air temperature of the environment of the high definition camera and outputting the tested air temperature as a current air temperature;

a DSP chip, coupled to the air-temperature testing device, the ultrasonic transmitting device and the ultrasonic receiving device, for calculating a vertical height of the high definition camera from the ground as a current height output based on the current air temperature, the time of transmitting the ultrasonic signal and the time for receiving the ultrasonic signal, and the DSP chip further comprising a built-in storage unit for storing a temperature-speed comparison table, and the temperature-speed comparison table having an ultrasonic wave propagation speed corresponding to each temperature range, and the temperature-speed comparison table using the temperature range as an index value, and the storage unit being provided for storing a predetermined height which is a shooting height set by the high definition camera; the calculation for the DSP chip to obtain the vertical height of the high definition camera from the ground based on the current air temperature, the time of transmitting the ultrasonic signal and the time of receiving the ultrasonic signal comprising the steps of: obtaining the temperature-speed comparison table from the storage unit, confirming a temperature range of the current air temperature to obtain a corresponding ultrasonic wave propagation speed from the temperature-speed comparison table and use the ultrasonic wave propagation speed as a current propagation speed, and calculating the vertical height of the high definition camera from the ground based on the current propagation speed, the time of transmitting the ultrasonic signal and the time of receiving the ultrasonic signal;

a high definition camera, installed on the housing of the electrical blow dryer, for performing a high-definition camera operation to an environment of the electrical blow to output a high-definition camera image;

a permanent-magnet brushless motor, coupled to the DSP chip and the high definition camera, for receiving the current height and the predetermined height, and controlling the high definition camera to adjust the position of the high definition camera from the current height to the predetermined height;

a type analysis device, coupled to the high definition camera, for receiving the high-definition camera image, and analyzing the amplitude of various noise in the high-definition camera image to confirm a primary noise type of the largest amplitude and a of the second largest amplitude secondary noise type;

a type selection device, coupled to the type analysis device, for receiving the primary noise type and the secondary noise type, and confirming a corresponding primary filtering mode based on the primary noise type, and confirming a corresponding secondary filtering mode based on the secondary noise type;

a filter execution device, coupled to the type analysis device and the type selection device, for using the primary filtering mode to execute a filtering process of the high-definition camera image, and then using the secondary filtering mode to execute a filtering processing of the filter processing result to obtain a two-stage filtered image;

a sub-image fetching device, coupled to the filter execution device, for receiving the two-stage filtered image, and performing a contour fetch of each target in the two-stage filtered image to obtain each distribution area of each target in the two-stage filtered image, and also used for splitting blocks of the two-stage filtered image to obtain each sub-image;

a foreground cutting device, coupled to the sub-image fetching device, for receiving each sub-image of the two-stage filtered image, and detecting a dynamic range of each sub-image, and adjusting a threshold of the sub-image used in a stripping background for each sub-image based on the width of the dynamic range, and further executing the following for each sub-image: using the adjusted threshold for performing a foreground fetch of the sub-image to obtain a corresponding foreground area, and combining each corresponding foreground area of each sub-image, and performing a fitting processing of the combined result to obtain a foreground operation image, and outputting the foreground operation image; the adjustment of the threshold of the corresponding sub-image used for the stripping background based on the width of the dynamic range in the foreground cutting device including a condition: the larger the dynamic range, the larger the threshold of the corresponding sub-image used for the stripping background;

a smoothing device, coupled to the foreground cutting device, for receiving the foreground operation image, and executing a smoothing of the foreground operation image for a number of times corresponding to a signal-to-noise ratio of the foreground operation image to obtain and output a corresponding multiple-times smoothed image;

a target preliminary testing device, coupled to the smoothing device, for receiving the multiple-times smoothed image, and detecting an existence of each target in the multiple-times smoothed image, and using the quantity of targets existed in the multiple-times smoothed image as a current target quantity, and outputting the current target quantity;

an image decision device, coupled to the target preliminary testing device, for receiving the current target quantity, and issuing an excessive target signal when the current target quantity is over-limit, and issuing a target normal signal when the target quantity is not over-limit;

a contrast enhancement device, coupled to the target preliminary testing device and the target decision device, for receiving the multiple-times smoothed image, and executing a contrast enhancement of the multiple-times smoothed image to obtain a corresponding contrast enhanced image when the excessive target signal is received, and executing a contrast enhancement of the multiple-times smoothed image for a number of times directly proportional to the current target quantity;

a content analysis device, coupled to the contrast enhancement device, for receiving the contrast enhanced image, and performing a content match of the contrast enhanced image and a soap standard profile to confirm a content match percentage, and confirming an existence of the corresponding soap if the content match percentage is greater than or equal to a predetermined percentage threshold, or else confirming a non-existence of the corresponding soap;

wherein, the on-site alarm device is coupled to the content analysis device for performing a corresponding voice alarm operation when the content analysis device confirms the existence of the corresponding soap.

The specific structure of the multifunctional handle-type electrical blow dryer of the present disclosure will be further described as follows.

In the multifunctional handle-type electrical blow dryer, the contrast enhancement of the multiple-times smoothed image is stopped in the contrast enhancement device when the target normal signal is received.

In the multifunctional handle-type electrical blow dryer, the on-site alarm device is provided for stopping the corresponding voice alarm operation when the on-site measured temperature is not over-limit.

In the multifunctional handle-type electrical blow dryer, the on-site alarm device is provided for stopping the corresponding voice alarm operation when the non-existence of the corresponding soap is received.

In the multifunctional handle-type electrical blow dryer, a uniform division is performed in each distribution area in the sub-image fetching device and includes the condition: the larger the distribution area, the larger the size of the divided and obtained sub-image.

In the multifunctional handle-type electrical blow dryer, a uniform division of the two-stage filtered image is performed in each distribution area to obtain a sub-image with a size smaller than the size of the sub-image obtained without performing the uniform division in the distribution area.

In the multifunctional handle-type electrical blow dryer, the permanent-magnet brushless motor is provided for adjusting the position of the high definition camera from the current height to the predetermined height and then transmitting a position home bit signal.

In the multifunctional handle-type electrical blow dryer, the high definition camera is provided for starting a shooting operation of the high-definition camera image when the position home bit signal transmitted by the permanent-magnet brushless motor is received.

In addition, the DSP chip is also known as a digital signal processor, which is a special microprocessor specially suitable for the operation of digital signal processing, and its main application is to carry out various digital signal processing algorithms quickly.

According to the requirements of the digital signal processing, the DSP chip generally has the following main features: (1) The DSP chip can complete a multiplication and an addition once within a computing speed; (2) The DSP chip separates programs and data spaces, so that instructions and data can be accessed simultaneously; (3) Each DPS chip includes a fast RAM, so that two DPS chips can be accessed simultaneously through independent data buses; (4) The DPS chip provides low or no overhead loop and jumping/switching hardware support; (5) The DPS chip provides fast interrupt handling and hardware I/O support; (6) The DPS chip includes a plurality of hardware address generators operated in a single cycle; (7) The DPS chip can execute several operations in a single cycle; (8) The DPS chip supports a pipeline operation, so that the operations such as fetch, decode and execution can be carried out in the manner of overlapped execution.

The multifunctional handle-type electrical blow dryer of the present disclosure improves the technical issue on the incomplete functions of the conventional electrical blow dryer by obtaining the distribution area with the existence of targets and the non-distribution area without the existence of targets in the image, and implementing a differential image division mode. In addition, the present disclosure further uses a high-precision foreground cutting mechanism to facilitate various subsequent image operations and determines the timing of contrast enhancement of the high-definition image and its number of times based on a preliminary detection result of the target quantity of the image, so as to avoid unnecessary waste of computing resources. The present disclosure further uses the permanent-magnet brushless motor to correct the current position of the high definition camera and ensures the accuracy of the subsequent measurement result based on the ultrasonic wave propagation speed correction mechanism for testing. On the basis of the aforementioned high precision image processing, a custom detection of a soap target near the electrical blow dryer is performed to prevent the electrical blow dryer from blowing and melting the soap.

While the present disclosure has been described by means of specific embodiments, numerous modifications and variations could be made thereto by those skilled in the art without departing from the scope and spirit of the present disclosure set forth in the claims.

What is claimed is:

1. A multifunctional handle-type electrical blow dryer, comprising:
a temperature measuring device, installed on a housing of the electrical blow dryer, and provided for measuring the on-site temperature of a position where the housing of the electrical blow dryer is configured to obtain a corresponding on-site measured temperature and output the on-site measured temperature;
an on-site alarm device, installed on a side of the temperature measuring device, for receiving the on-site measured temperature, and performing a corresponding voice alarm operation when the on-site measured temperature is over-limit;
a data testing mechanism, comprising an ultrasonic transmitting device, an ultrasonic receiving device and an air-temperature testing device, and the ultrasonic transmitting device being installed on a high definition camera and provided for transmitting an ultrasonic signal towards the ground and recording the time of transmitting the ultrasonic signal, and the ultrasonic receiving device being installed on the high definition camera and disposed near the ultrasonic transmitting device for receiving the ultrasonic signal transmitted by the ultrasonic transmitting device in a direction towards the ground and reflected from the ground, and recording the time for receiving the ultrasonic signal ground transmitted by the ultrasonic transmitting device and reflected from the ground, and the air-temperature testing device being installed on the high definition camera for testing the air temperature of the environment of the high definition camera and outputting the tested air temperature as a current air temperature;
a DSP chip, coupled to the air-temperature testing device, the ultrasonic transmitting device and the ultrasonic receiving device, for calculating a vertical height of the high definition camera from the ground as a current height output based on the current air temperature, the time of transmitting the ultrasonic signal and the time for receiving the ultrasonic signal, and the DSP chip further comprising a built-in storage unit for storing a temperature-speed comparison table, and the temperature-speed comparison table having an ultrasonic wave propagation speed corresponding to each temperature range, and the temperature-speed comparison table using the temperature range as an index value, and the storage unit being provided for storing a predetermined height which is a shooting height set by the high definition camera, the calculation for the DSP chip to obtain the vertical height of the high definition camera from the ground based on the current air temperature, the time of transmitting the ultrasonic signal and the time of receiving the ultrasonic signal comprising the steps of:
obtaining the temperature-speed comparison table from the storage unit, confirming a temperature range of the current air temperature to obtain a corresponding ultrasonic wave propagation speed from the temperature-speed comparison table and use the ultrasonic wave propagation speed as a current propagation speed, and
calculating the vertical height of the high definition camera from the ground based on the current propagation speed, the time of transmitting the ultrasonic signal and the time of receiving the ultrasonic signal;
a high definition camera, installed on the housing of the electrical blow dryer, for performing a high-definition camera operation to an environment of the electrical blow to output a high-definition camera image;
a permanent-magnet brushless motor, coupled to the DSP chip and the high definition camera, for receiving the current height and the predetermined height, and controlling the high definition camera to adjust the position of the high definition camera from the current height to the predetermined height;
a type analysis device, coupled to the high definition camera, for receiving the high-definition camera image, and analyzing the amplitude of various noise in the high-definition camera image to confirm a primary noise type of the largest amplitude and a of the second largest amplitude secondary noise type;
a type selection device, coupled to the type analysis device, for receiving the primary noise type and the secondary noise type, and confirming a corresponding primary filtering mode based on the primary noise type, and confirming a corresponding secondary filtering mode based on the secondary noise type;
a filter execution device, coupled to the type analysis device and the type selection device, for using the primary filtering mode to execute a filtering process of the high-definition camera image, and then using the secondary filtering mode to execute a filtering processing of the filter processing result to obtain a two-stage filtered image;
a sub-image fetching device, coupled to the filter execution device, for receiving the two-stage filtered image, and performing a contour fetch of each target in the two-stage filtered image to obtain each distribution area of each target in the two-stage filtered image, and also used for splitting blocks of the two-stage filtered image to obtain each sub-image;
a foreground cutting device, coupled to the sub-image fetching device, for receiving each sub-image of the two-stage filtered image, and detecting a dynamic range of each sub-image, and adjusting a threshold of the sub-image used in a stripping background for each sub-image based on the width of the dynamic range, and further executing the following for each sub-image: using the adjusted threshold for performing a foreground fetch of the sub-image to obtain a corresponding foreground area, and combining each corresponding foreground area of each sub-image, and performing a fitting processing of the combined result to obtain a foreground operation image, and outputting the foreground operation image; the adjustment of the threshold of the corresponding sub-image used for the stripping background based on the width of the dynamic range in the foreground cutting device including a condition:
the larger the dynamic range, the larger the threshold of the corresponding sub-image used for the stripping background; a smoothing device, coupled to the foreground cutting device, for receiving the foreground operation image, and executing a smoothing of the foreground operation image for a number of times corresponding to a signal-to-noise ratio of the foreground operation image to obtain and output a corresponding multiple-times smoothed image;
a target preliminary testing device, coupled to the smoothing device, for receiving the multiple-times smoothed image, and detecting an existence of each target in the multiple-times smoothed image, and using the quantity of targets existed in the multiple-times smoothed image as a current target quantity, and outputting the current target quantity;
an image decision device, coupled to the target preliminary testing device, for receiving the current target quantity, and issuing an excessive target signal when the current target quantity is over-limit, and issuing a target normal signal when the target quantity is not over-limit;
a contrast enhancement device, coupled to the target preliminary testing device and the target decision device, for receiving the multiple-times smoothed image, and executing a contrast enhancement of the multiple-times smoothed image to obtain a corresponding contrast enhanced image when the excessive target signal is received, and executing a contrast enhancement of the multiple-times smoothed image for a number of times directly proportional to the current target quantity;
a content analysis device, coupled to the contrast enhancement device, for receiving the contrast enhanced image, and performing a content match of the contrast enhanced image and a soap standard profile to confirm a content match percentage, and confirming an existence of the corresponding soap if the content match percentage is greater than or equal to a predetermined percentage threshold, or else confirming a non-existence of the corresponding soap;
wherein the on-site alarm device is coupled to the content analysis device for performing a corresponding voice alarm operation when the content analysis device confirms the existence of the corresponding soap.

2. The multifunctional handle-type electrical blow dryer according to claim 1, wherein the contrast enhancement of the multiple-times smoothed image is stopped in the contrast enhancement device when the target normal signal is received.

3. The multifunctional handle-type electrical blow dryer according to claim 2, wherein the on-site alarm device is provided for stopping the corresponding voice alarm operation when the on-site measured temperature is not over-limit.

4. The multifunctional handle-type electrical blow dryer according to claim 3, wherein the on-site alarm device is provided for stopping the corresponding voice alarm operation when the non-existence of the corresponding soap is received.

5. The multifunctional handle-type electrical blow dryer according to claim 4, wherein a uniform division is performed in each distribution area in the sub-image fetching device and includes the condition: the larger the distribution area, the larger the size of the divided and obtained sub-image.

6. The multifunctional handle-type electrical blow dryer according to claim 5, wherein a uniform division of the two-stage filtered image is performed in each distribution area to obtain a sub-image with a size smaller than the size of the sub-image obtained without performing the uniform division in the distribution area.

7. The multifunctional handle-type electrical blow dryer according to claim 6, wherein the permanent-magnet brushless motor is provided for adjusting the position of the high definition camera from the current height to the predetermined height and then transmitting a position home bit signal.

8. The multifunctional handle-type electrical blow dryer according to claim 7, wherein the high definition camera is provided for starting a shooting operation of the high-definition camera image when the position home bit signal transmitted by the permanent-magnet brushless motor is received.
